(19) United States
(12) Patent Application Publication
(10) Pub. No.: US 2002/0059600 A1
(43) Pub. Date: May 16, 2002

(54) Digital broadcasting receiver

(75) Inventors: Kiyoshi Matsumoto, Osaka (JP); Masako Wakisaka, Osaka (JP)

Correspondence Address: ARENT FOX KINTNER PLOTKIN & KAHN, PLLC, Suite 600, 1050 Connecticut Avenue, N.W., Washinggton, DC, 20036-5339, US

(73) Assignee: SANYO ELECTRIC CO., LTD.

(21) Appl. No.: 09/884,102

(22) Filed: Jun. 20, 2001

(30) Foreign Application Priority Data
Jun. 20, 2000 (JP) 183931/2000

(51) Int. Cl. G06F 3/00; H04N 5/445; G06F 13/00

(52) U.S. Cl. 725/40

(57) ABSTRACT

A system controller reads out program information from a memory to compose a program table, causes the program table to be displayed on a screen of a CRT using an OSD circuit, issues a conversion command to a scanning line conversion circuit, and displays reduced video of the selected program on a screen of the CRT. Further, the system controller judges whether or not the selected program has not been contracted yet, for example, on the basis of information provided from a CA module, reads out from a nonvolatile memory message data representing “You cannot view” if the selected program has not been contracted yet, and causes the message to be displayed on a reduced video display area using the OSD circuit.

### BACKGROUND OF THE INVENTION

1. Field of the Invention

The present invention relates generally to a digital broadcasting receiver for receiving digital broadcasting. There is digital broadcasting for compressing a video/audio signal using a digital signal compression technique as well as broadcasting a stream on which video/audio digital signals on a plurality of programs are time-division multiplexed (a transport stream) via a transponder. A plurality of transponders exist. Moreover, a plurality of channels are multiplexed on each of the transponders. Accordingly, the number of channels reaches an enormous number extending to not less than a hundred.

On the other hand, a broadcasting receiver for receiving such digital multichannel broadcasting selects by a tuner one of the plurality of transponders in the digital broadcasting received through a dedicated antenna, selects by demultiplexing processing one of the plurality of channels included in the one transponder, and decodes a digital signal on the selected channel, to output a video/audio signal.

In such digital television broadcasting, service information such as functions which conventional analog broadcasting does not have, for example, information related to programs currently broadcast and programs to be broadcast in the future and notification from a communication enterpriser, together with inherent program data, are transmitted at predetermined time intervals. The digital broadcasting receiver receives the service information, and displays the received service information as a program table on a display by an EPG (Electronic Program Guide) screen display function. Accordingly, a user can efficiently select the program which he or she desires to view out of the programs in multi-channel broadcasting.

The convenience of channel selection by the user can be improved by reducing and displaying received video in the selected program while displaying the program table. When the program whose receiving is not allowed, for example, is selected, however, nothing is displayed in a reduced display area of the received video, and a square black area is formed therein. Accordingly, it may be judged, wrongly, that the television broadcasting receiver developed a fault. Further, even when the user selects a radio program, a wrong judgment may be made.

In view of the above-mentioned circumstances, an object of the present invention is to provide a digital broadcasting receiver capable of solving a problem in a case where nothing is displayed in a reduced display area of received video.

### SUMMARY OF THE INVENTION

In order to solve the above-mentioned problem, a digital broadcasting receiver according to the present invention is characterized by comprising electronic program guide display means for displaying program information on a screen utilizing an on-screen display circuit on the basis of service information included in digital broadcasting; received video display means for reducing received video and displaying the video, together with the program information; information acquisition means for acquiring information related to a selected channel; and message display means for creating a message corresponding to the acquired information and displaying the message in an area where the received video is reduced and displayed. Examples of the information acquired by the information acquisition means include contract information related to the selected channel, preview information related to the selected channel, information indicating whether or not the selected channel is a radio program, and information indicating whether or not the selected channel corresponds to the viewing age limit.

In the above-mentioned construction, the program which has not been contracted yet is selected. Even if the reduced display area of the received video is displayed in black, therefore, a message saying “You cannot view”, for example, is displayed in the reduced display area by the message display means. Accordingly, it is possible to prevent the user from judging, wrongly, that the digital broadcasting receiver developed a fault. Further, it is possible to display a message saying “Being previewed” while a PPV (Pay Per View) program is being previewed, a message saying “Preview is over” after the preview ends, and a message saying “This is radio program” when the radio program is selected.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a digital broadcasting receiver according to an embodiment of the present invention;

FIG. 2 is an illustration showing a state where received video is reduced and displayed on an EPG screen in the embodiment of the present invention; and

FIG. 3 is a flow chart showing the contents of processing in the embodiment of the present invention.

### DESCRIPTION OF THE PREFERRED EMBODIMENTS

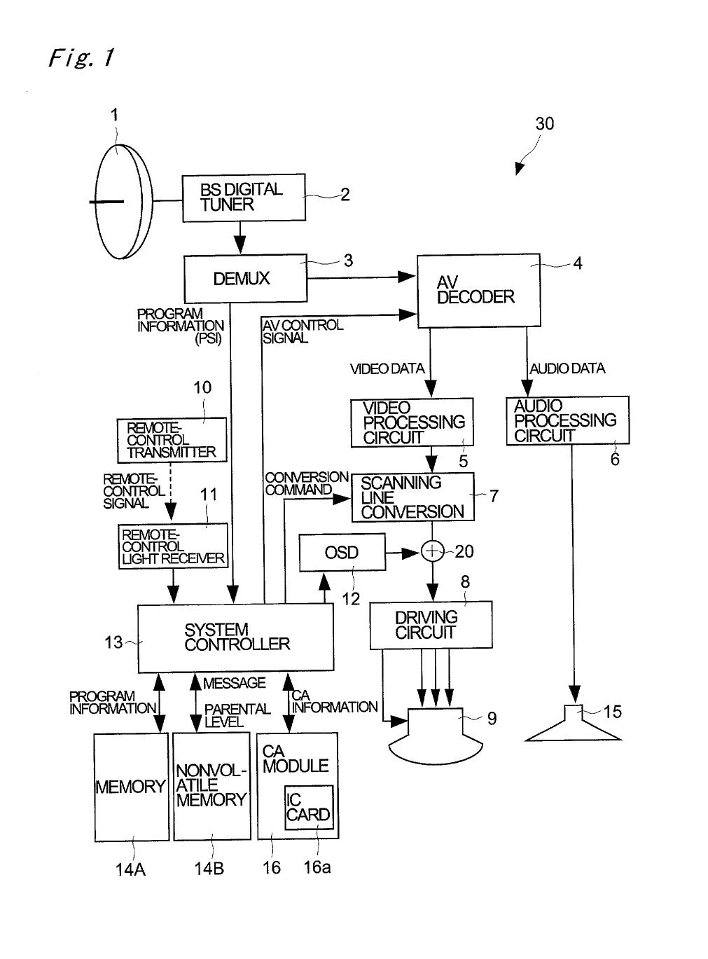

An embodiment of the present invention will be described on the basis of FIGS. 1 to 3, which illustrates a case where a user views BS (Broadcasting via Satellite) digital broadcasting as digital television broadcasting.

An antenna 1 shown in FIG. 1 is arranged in a predetermined direction outdoors, and receives a digital broadcasting signal fed from the BS. The antenna 1 generally comprises a frequency converter, and feeds to a BS digital tuner 2 the received/frequency-converted signal.

The BS digital tuner 2 takes out a signal having a particular frequency out of received high-frequency digital modulation signals. That is, it performs processing for selecting one of a plurality of transponders in digital broadcasting. Further, the tuner 2 comprises a demodulation circuit, an inverse interleave circuit, an error correcting circuit, and so forth, thereby to demodulate the selected digital modulation signal and output a transport stream.

A demultiplexer (DEMUX) 3 separates the transport stream received from the tuner 2 into a video transport packet and an audio transport packet based on MPEG2 (Moving Picture Experts Group2) and PSI (Program Specific Information). The demultiplexer 3 feeds the video transport packet and the audio transport packet to an AV decoder 4, and feeds service information included in the PSI, for example, to a system controller 13. As described in the foregoing, a plurality of channels are multiplexed on the transport stream. Processing for selecting any one of the channels can be performed by taking out from the PSI data indicating which packet ID in the transport stream is used to multiplex the arbitrary channel. The selection of the transport stream (the selection of the transponder) can be made on the basis of the PSI.

The AV decoder 4 comprises a video decoder for decoding the video transport packet and an audio decoder for decoding the audio transport packet. The video decoder decodes an inputted variable length code to find a quantization factor and a motion vector, to carry out inverse DCT (Discrete Cosine Transformation) and motion compensation control based on the motion vector. The audio decoder decodes a coded signal which has been inputted, to generate audio data.

A video processing circuit 5 receives the video data from the AV decoder 4 and subjects the received video data to digital-to-analog conversion, to generate a video signal. An audio signal processing circuit 6 receives the audio data outputted from the AV decoder 4 and subjects the received audio data to digital-to-analog conversion, to generate an analog signal of a right (R) sound and an analog signal of a left (L) sound, for example.

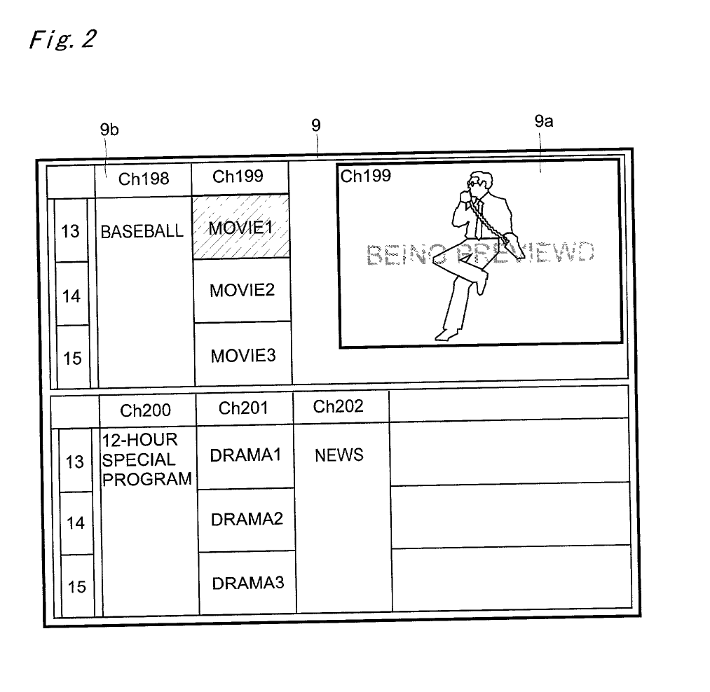

A scanning line conversion circuit 7 outputs inputted video as it is when it does not receive a conversion command from the system controller 13, while generating video obtained by reducing the inputted video and outputting the generated video when it receives the conversion command from the system controller 13. Further, it receives the conversion command as well as display position information from the system controller 13, to perform processing based on the display position information. For example, an area where no received video is displayed (a program table area 9b) can be created on the left and lower sides of a screen in such a manner that a received video area 9a which has been reduced is arranged at the upper right, as shown in FIG. 2.

The basic scanning line conversion circuit comprises an analog-to-digital (A/D) converter, a thinning processor, and a digital-to-analog (D/A) converter for example. The A/D converter converts each of component signals (R-Y, B-Y, and Y) into a digital signal. The thinning processor performs thinning processing of the video data so as to reduce the video to a previously set size and writes the thinned video data into a memory (not shown). The D/A converter converts the video data read out of the memory into an analog signal at predetermined timing, and outputs the component signal which is reduced video.

An OSD (On-Screen Display) circuit 12 outputs to an adder 20 bit map data based on character information and color information whose output instruction is issued from the system controller 13. The adder 20 incorporates a video signal based on the bit map data into the video signal outputted from the video processing circuit 5, and feeds the video signal to a driving circuit 8. By the OSD circuit 12, EPG (Electronic Program Guide) screen display (display of a program table, program details, etc.) based on the service information included in the above-mentioned PSI received by the system controller 13 is realized.

A CRT (Cathode Ray Tube) 9 displays video by video signals (an R (Red) signal, a G (Green) signal, a B (Blue) signal, a vertical synchronizing signal, and horizontal synchronizing signal) fed from the driving circuit 8. Further, a speaker 15 outputs audio by the audio signal outputted from the audio processing circuit 6.

A remote-control transmitter 10 is a transmitter for sending out a command to a corresponding broadcasting receiver 30. When a key (not shown) provided in the remote-control transmitter 10 is operated, signal light (a remote-control signal) meaning a command corresponding to the key is fed from a light emitting unit (not shown). A remote-control light receiver 11 receives the signal light, converts the received signal light into an electric signal, and feeds the electric signal to the system controller 13. The remote-control transmitter 10 is provided with a button for performing EPG screen display and a button for releasing the EPG screen display, which are not illustrated.

A memory 14A stores service information (the contents of a program, the details of the program, the time when the program begins, the time when the program ends, information indicating that the program is a radio program, etc.) which will compose a program table or the like. A nonvolatile memory 14B stores message information. Prepared as a message are “Preview is over”, “Being previewed”, “This is radio program”, and “You cannot view”.

An IC card 16a stores key information for making it possible to view paid broadcasting and purchase history information related to a PPV (Pay Per View) program for which the user is to be charged for each program. A CA (Conditional Access) module 16 performs write processing and read-out processing of the various information between the system controller 13 and the IC card 16a. The various information include preview information making it possible to view a program which has not been purchased yet only for a predetermined period (time) in addition to the key information and the purchase history information which are required to view the paid digital broadcasting. The preview information a makes it possible for the system controller 13 to judge whether the program selected by the user is being previewed or a preview period expires.

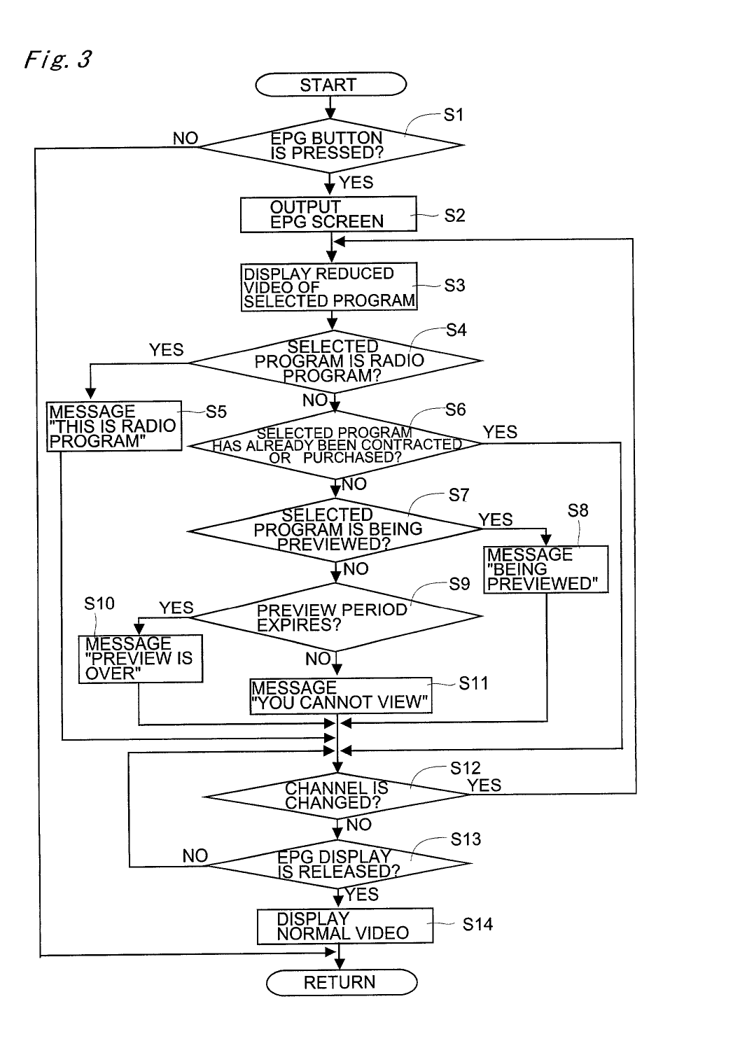

FIG. 3 is a flow chart showing the contents of processing in the present embodiment. It is first judged whether or not a button for performing EPG screen display is pressed (step S1). When the button is pressed, the system controller 13 reads out program information from the memory 14A to form a program table, and causes the program table to be displayed on a screen of the CRT 9 using the OSD circuit 12 (step 2). Further, the system controller 13 issues a conversion command to the scanning line conversion circuit 7, to display reduced video of the selected program on the screen of the CRT 9 (step S3).

The system controller 13 judges whether or not the selected program is a radio program on the basis of PSI (step S4), reads out, if the selected program is the radio program, message data representing “This is radio program” stored in the nonvolatile memory 14B, and causes the message to be displayed on a reduced video display area using the OSD circuit 12 (step S5). At this time, there is no received video. Accordingly, the reduced video display area is changed into a black background, so that the message is displayed in a color other than black. If the selected program is not the radio program, the system controller 13 judges whether or not the selected program has already been contracted or purchased on the basis of information provided from the CA module 16 (step S6). When the answer is in the affirmative at the step S6, the program proceeds to the step S12. That is, only the received video is displayed in the reduced video display area.

When the answer is in the negative at the step S6, the system controller 13 judges whether or not the selected program is being previewed on the basis of the information provided from the CA module 16 (step S7), reads out, if the selected program is being previewed, message data representing “Being previewed” stored in the nonvolatile memory 14B, and causes the message to be displayed on the reduced video display area using the OSD circuit 12 (step S8; see FIG. 2).

In the present embodiment, “Being previewed”is displayed in a semitransparent state such that preview video can be seen. If the selected program is not being previewed, it is judged whether or not a preview period expires (step S9), reads out, if the preview period expires, message data representing “Preview is over” stored in the nonvolatile memory 14B, and causes the message to be displayed on the reduced video display area using the OSD circuit 12 (step S10). At this time, there is no received video. Accordingly, the reduced video display area is changed into a black background, so that the message is displayed in a color other than black.

When it is judged at the step S9 that the answer is in the negative, the program has not been contracted yet. Accordingly, message data representing “You cannot view” stored in the nonvolatile memory 14B is read out, and is displayed in the reduced video display area (step S11). At this time, there is no received video. Accordingly, the reduced video display area is changed into a black background, so that the message is displayed in a color other than black.

It is then judged whether or not a channel is changed (step S12). When the channel is changed, the program proceeds to the step S3. At the step S3, a program on the changed channel is reduced and displayed. When the channel is not changed, it is judged whether or not EPG screen display is released (step S13). When the EPG screen display is released, the received video is displayed on the whole of the screen (step S14).

The system controller 13 acquires the parental level of a channel selected by the user, compares the parental level with the set parental level stored in the nonvolatile memory 14B, reads out message data representing “You cannot view” and “Enter identification number” from the nonvolatile memory 14B when the parental level of a program to be viewed exceeds the set parental level, and causes the message to be displayed in the reduced video display area, which is not shown in the above-mentioned flow chart.

As described in the foregoing, according to the present invention, even if the reduced display area of the received video is displayed in black because the program which has not been contracted yet is selected, therefore, the message saying “You cannot view”, for example, is displayed in the reduced display area by the message display means. Accordingly, it is possible to prevent the user from judging, wrongly, that the digital broadcasting receiver developed a fault.

Furthermore, the message saying “Being previewed” is displayed while the PPV program is being previewed, the message saying “Preview is over” is displayed after the preview ends, the message saying “This is radio program” is displayed when the radio program is selected. Accordingly, the user can easily know what program is selected by the user himself or herself using the messages, thereby producing the effect of comfortably performing a program selecting operation.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital broadcasting receiver comprising:
electronic program guide display means for displaying program information on a screen utilizing an on-screen display circuit on the basis of service information included in digital broadcasting;
received video display means for reducing received video and displaying the video, together with said program information;
information acquisition means for acquiring information related to a selected channel; and
message display means for creating a message corresponding to the acquired information and displaying the message in an area where the received video is reduced and displayed.

2. The digital broadcasting receiver according to claim 1, wherein
said information acquisition means acquires contract information related to the selected channel.

3. The digital broadcasting receiver according to claim 1, wherein
said information acquisition means acquires preview information related to the selected channel.

4. The digital broadcasting receiver according to claim 1, wherein
said information acquisition means acquires information indicating whether or not the selected channel is a radio program.

5. The digital broadcasting receiver according to claim 1, wherein
said information acquisition means acquires information indicating whether or not the selected channel corresponds to the viewing age limit.

6. The digital broadcasting receiver according to claim 1, wherein
said message display means displays a message in a semitransparent state in an area where said received video is reduced and displayed.

7. The digital broadcasting receiver according to claim 2, wherein
said message display means displays a message in a semitransparent state in an area where said received video is reduced and displayed.

8. The digital broadcasting receiver according to claim 3, wherein
said message display means displays a message in a semitransparent state in an area where said received video is reduced and displayed.

9. The digital broadcasting receiver according to claim 4, wherein
said message display means displays a message in a semitransparent state in an area where said received video is reduced and displayed.

10. The digital broadcasting receiver according to claim 5, wherein
said message display means displays a message in a semitransparent state in an area where said received video is reduced and displayed.
